(19) United States
(12) Patent Application Publication
(10) Pub. No.: US 2025/0226915 A1
(43) Pub. Date: Jul. 10, 2025

(54) PARTIAL CBG BASED LINK ADAPTATION

(71) Applicant: QUALCOMM Incorporated, San Diego, CA (US)

(72) Inventors: Jacob PICK, Mevaseret Zion (IL); Shay LANDIS, Hod Hasharon (IL); Gideon Shlomo KUTZ, Ramat Hasharon (IL); Amit BAR-OR TILLINGER, Tel-Aviv (IL); Peer BERGER, Hod Hasharon (IL)

(21) Appl. No.: 18/408,468

(22) Filed: Jan. 9, 2024

(51) Int. Cl. H04L 1/00; H04L 1/1812; H04W 72/21; H04W 76/10

(52) U.S. Cl. CPC H04L 1/0057; H04L 1/1812; H04W 72/21; H04W 76/10

(57) ABSTRACT

Methods, apparatuses, and computer-readable media are provided including approaches for partial code block group (CBG)-based link adaptation in wireless communication. An apparatus sends a message to a wireless device indicating a partial CBG, and obtains retransmitted data in the partial CBG and additional data in the remainder of the CBG in response to a non-acknowledgment of the CBG. The partial CBG is based on mutual information between the apparatus and the wireless device representing an average spectral efficiency observed from historical CBGs. Support for link adaptation based on the partial CBG may be indicated in capability information, and the granularity of the partial CBG may be confirmed prior to establishing a radio resource control connection. These methods boost throughput, provide efficient resource utilization, and ensure compatibility without compromising quality of service.

### TECHNICAL FIELD

The present disclosure generally relates to wireless communication, and more particularly, to wireless communication systems that provide code block group (CBG)-based link adaptation.

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

One innovative aspect of the subject matter described in this disclosure may be implemented in a method for wireless communication performable at a first wireless device, which may be a user equipment (UE) or a network entity such as a base station. The method includes sending, to a second wireless device, a message indicating a partial code block group, the partial code block group being indicated via a quantity representing a fraction of a code block group, and obtaining, in response to a non-acknowledgment of the code block group, retransmitted data in the partial code block group and additional data in a remainder of the code block group.

Another innovative aspect of the subject matter described in this disclosure may be implemented in an apparatus for wireless communication, which may be a UE or a network entity such as a base station. The apparatus includes one or more memories, and one or more processors each communicatively coupled with at least one of the one or more memories. The one or more processors, individually or in any combination, are operable to cause the apparatus to send, to a wireless device, a message indicating a partial code block group, the partial code block group being indicated via a quantity representing a fraction of a code block group, and obtain, in response to a non-acknowledgment of the code block group, retransmitted data in the partial code block group and additional data in a remainder of the code block group.

Another innovative aspect of the subject matter described in this disclosure may be implemented in an apparatus for wireless communication, which may be a UE or a network entity such as a base station. The apparatus includes means for sending, to a wireless device, a message indicating a partial code block group, the partial code block group being indicated via a quantity representing a fraction of a code block group, and means for obtaining, in response to a non-acknowledgment of the code block group, retransmitted data in the partial code block group and additional data in a remainder of the code block group.

Another innovative aspect of the subject matter described in this disclosure may be implemented in one or more non-transitory, computer-readable media comprising computer executable code. The code when executed by one or more processors causes the one or more processors to, individually or in combination, send, to a wireless device, a message indicating a partial code block group, the partial code block group being indicated via a quantity representing a fraction of a code block group, and obtain, in response to a non-acknowledgment of the code block group, retransmitted data in the partial code block group and additional data in a remainder of the code block group.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1A is a diagram illustrating an example of a wireless communications system and an access network.

FIG. 1B shows a diagram illustrating an example disaggregated base station architecture.

FIG. 2A is a diagram illustrating an example of a first subframe within a 5G NR frame structure.

FIG. 2B is a diagram illustrating an example of DL channels within a 5G NR subframe.

FIG. 2C is a diagram illustrating an example of a second subframe within a 5G NR frame structure.

FIG. 2D is a diagram illustrating an example of UL channels within a 5G NR subframe.

FIG. 3 is a block diagram illustrating an example of a first device and a second device involved in wireless communication.

FIG. 4 is a diagram illustrating an example of data that a receiver may utilize to calculate a partial code block group (CBG) in a partial CBG-based link adaptation scheme.

FIGS. 5A and 5B are diagrams illustrating examples of call flows between a base station and a UE respectively for partial CBG downlink (DL) and uplink (UL) link adaptation.

FIG. 6 is a diagram illustrating examples of simulations performed to validate the partial CBG link adaptation method of the present disclosure.

FIG. 7 is a diagram illustrating an example of a call flow between a UE and a network entity such as a base station.

FIG. 8 is a flowchart of an example method of wireless communication performable at a wireless device.

FIG. 9 is a diagram illustrating an example of a hardware implementation for an apparatus or wireless device.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

Various aspects of the subject matter described in this disclosure relate generally to wireless communication, and more particularly to partial code block group (CBG)-based link adaptation. Some aspects specifically relate to apparatuses, methods, and computer-readable media that enhance throughput efficiency by implementing a CBG re-transmission process in which only a portion of a CBG, rather than the full CBG, is re-transmitted in response to an acknowledgement (ACK)/non-acknowledgement (NACK) report. In some examples, an apparatus such as a user equipment (UE) or a base station sends a message to a wireless device indicating a partial code block group, and obtains retransmitted data in the partial code block group and additional data in a remainder of the code block group in response to a non-acknowledgment (NACK) of the code block group. The retransmitted data may be either downlink data or uplink data. The message may be sent in an ACK/NACK report with the NACK of the code block group, in a channel state feedback (CSF) report, or in uplink control information (UCI). The partial CBG may be based on mutual information between the apparatus and the wireless device representing an average spectral efficiency (SE) which is observed from code block groups transmitted or received in a historical window of one or more slots. For example, the partial CBG may be based on multiple SE thresholds corresponding to a target BLER, and a quantity indicating the partial CBG may be a function of these thresholds. Support for link adaptation based on the partial CBG may be indicated in transmitted or received capability information, and an acknowledgment of the support may indicate a granularity of the partial CBG prior to establishment of a radio resource control (RRC) connection between the apparatus and the wireless device.

Thus, particular aspects of the subject matter described in this disclosure may be implemented to realize one or more potential advantages. For example, the proposed apparatuses, methods, and computer-readable media may considerably boost throughput, in comparison to link adaptation methods where a full CBG is re-transmitted, without introducing additional delay or otherwise compromising quality of service (QOS). They may also provide more efficient utilization of resources by allowing UEs or network entities to request a retransmission of a failed portion of a CBG, rather than an entire CBG, through a minor overhead to CSF reporting, ACK/NACK reporting, or UCI reporting. For example, the apparatus may boost throughput by sending a message to the wireless device indicating the partial code block group, and obtaining retransmitted data in the partial code block group and additional data in a remainder of the code block group in response to the non-acknowledgment of the code block group. This process may be applied to both downlink and uplink data, enhancing the efficiency of both transmission directions. The apparatus may also provide more efficient utilization of resources by basing the partial code block group on mutual information between the apparatus and the wireless device, which represents the average spectral efficiency observed from code block groups transmitted or received in a historical window of one or more slots. Furthermore, the apparatus may adapt to varying link conditions by basing the partial CBG on multiple SE thresholds corresponding to a target BLER, and adjusting the quantity indicating the partial CBG as a function of these thresholds. Finally, the apparatus may ensure compatibility and efficient communication with other devices by indicating support for link adaptation based on the partial CBG in transmitted or received capability information, and confirming the granularity of the partial CBG prior to establishment of the RRC connection between the apparatus and the wireless device.

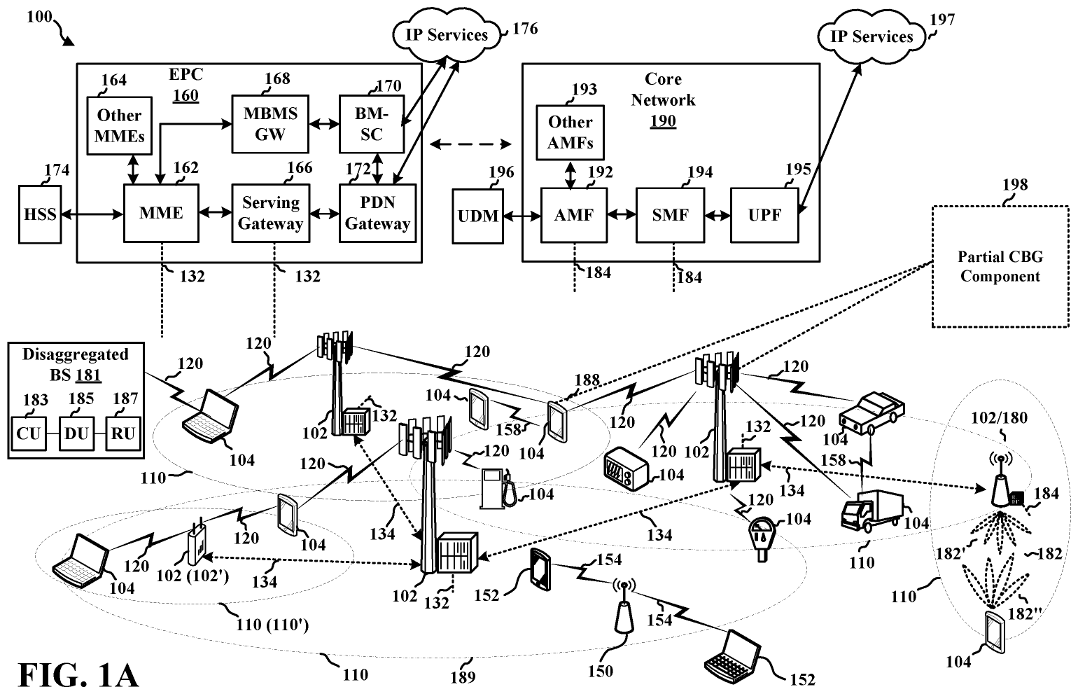

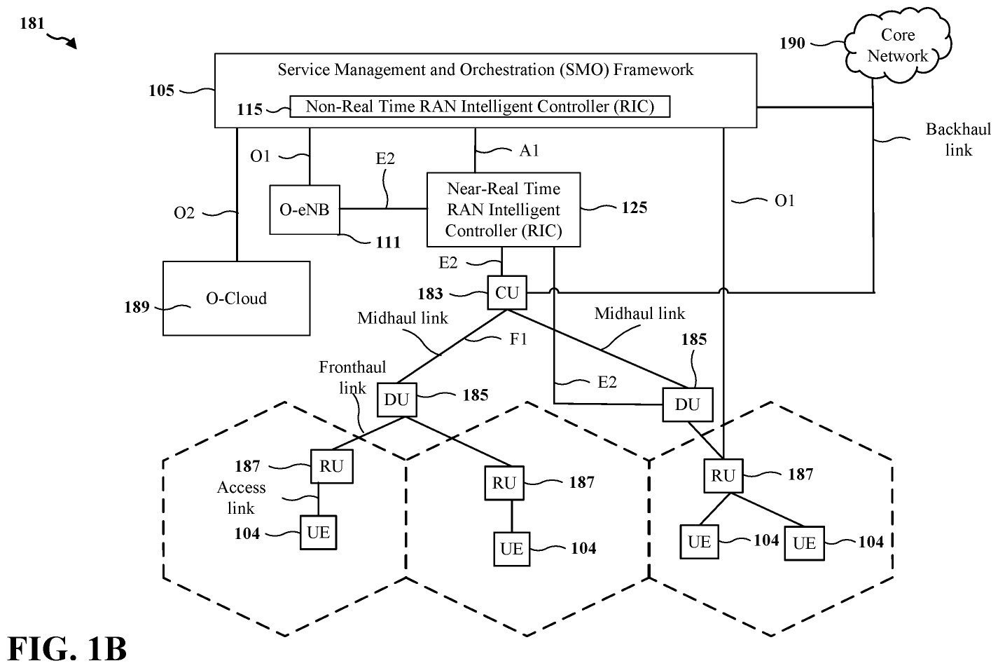

FIG. 1A is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QOS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Deployment of communication systems, such as 5G NR systems, may be arranged in multiple manners with various components or constituent parts. In a 5G NR system, or network, a network node, a network entity, a network device, a mobility element of a network, a RAN node, a core network node, a network element, or a network equipment, such as a BS, or one or more units (or one or more components) performing base station functionality, may be implemented in an aggregated or disaggregated architecture. For example, a BS (such as a Node B (NB), eNB, NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station 181 may be configured to utilize a protocol stack that is physically or logically distributed among two or more units (such as one or more central units (CU), one or more distributed units (DUs), or one or more radio units (RUs)). In some aspects, a CU 183 may be implemented within a RAN node, and one or more DUs 185 may be co-located with the CU, or alternatively, may be geographically or virtually distributed throughout one or multiple other RAN nodes. The DUs may be implemented to communicate with one or more RUs 187. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

FIG. 1B shows a diagram illustrating an example disaggregated base station 181 architecture. The disaggregated base station 181 architecture may include one or more CUs 183 that may communicate directly with core network 190 via a backhaul link, or indirectly with the core network 190 through one or more disaggregated base station units (such as a Near-Real Time RIC 125 via an E2 link, or a Non-Real Time RIC 115 associated with a Service Management and Orchestration (SMO) Framework 105, or both). A CU 183 may communicate with one or more DUs 185 via respective midhaul links, such as an F1 interface. The DUs 185 may communicate with one or more RUs 187 via respective fronthaul links. The RUs 187 may communicate respectively with UEs 104 via one or more radio frequency (RF) access links. In some implementations, the UE 104 may be simultaneously served by multiple RUs 187.

Each of the units, i.e., the CUS 183, the DUs 185, the RUs 187, as well as the Near-RT RICs 125, the Non-RT RICs 115 and the SMO Framework 105, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 183 may host higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 183. The CU 183 may be configured to handle user plane functionality (i.e., Central Unit-User Plane (CU-UP)), control plane functionality (i.e., Central Unit-Control Plane (CU-CP)), or a combination thereof. In some implementations, the CU 183 may be logically split into one or more CU-UP units and one or more CU-CP units. The CU-UP unit may communicate bidirectionally with the CU-CP unit via an interface, such as the E1 interface when implemented in an O-RAN configuration. The CU 183 may be implemented to communicate with the DU 185, as necessary, for network control and signaling.

The DU 185 may correspond to a logical unit that includes one or more base station functions to control the operation of one or more RUs 187. In some aspects, the DU 185 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 185 may further host one or more low PHY layers. Each layer (or module) may be implemented with an interface configured to communicate signals with other layers (and modules) hosted by the DU 185, or with the control functions hosted by the CU 183.

Lower-layer functionality may be implemented by one or more RUs 187. In some deployments, an RU 187, controlled by a DU 185, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 187 may be implemented to handle over the air (OTA) communication with one or more UEs 104. In some implementations, real-time and non-real-time aspects of control and user plane communication with the RU(s) 187 may be controlled by the corresponding DU 185. In some scenarios, this configuration may enable the DU(s) 185 and the CU 183 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements, which may be managed via an operations and maintenance interface (such as an O1 interface). For virtualized network elements, the SMO Framework 105 may be configured to interact with a cloud computing platform (such as an open cloud (O-Cloud) 189) to perform network element life cycle management (such as to instantiate virtualized network elements) via a cloud computing platform interface (such as an O2 interface). Such virtualized network elements may include, but are not limited to, CUs 183, DUs 185, RUs 187 and Near-RT RICs 125. In some implementations, the SMO Framework 105 may communicate with a hardware aspect of a 4G RAN, such as an open eNB (O-eNB) 111, via an O1 interface. Additionally, in some implementations, the SMO Framework 105 may communicate directly with one or more RUs 187 via an O1 interface. The SMO Framework 105 also may include the Non-RT RIC 115 configured to support functionality of the SMO Framework 105.

The Non-RT RIC 115 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 183, one or more DUs 185, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

Referring to FIGS. 1A and 1B, in certain aspects, the UE 104, aggregated base station (base station 102), or one or more components of disaggregated base station 181, may include partial code block group (CBG) component 198 that is configured to send a message to a wireless device indicating a partial CBG. The partial CBG is indicated via a quantity representing a fraction of a CBG. The partial CBG component 198 is also configured to obtain, in response to a non-acknowledgement of the CBG, retransmitted data in the partial CBG and additional data in a remainder of the CBG.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

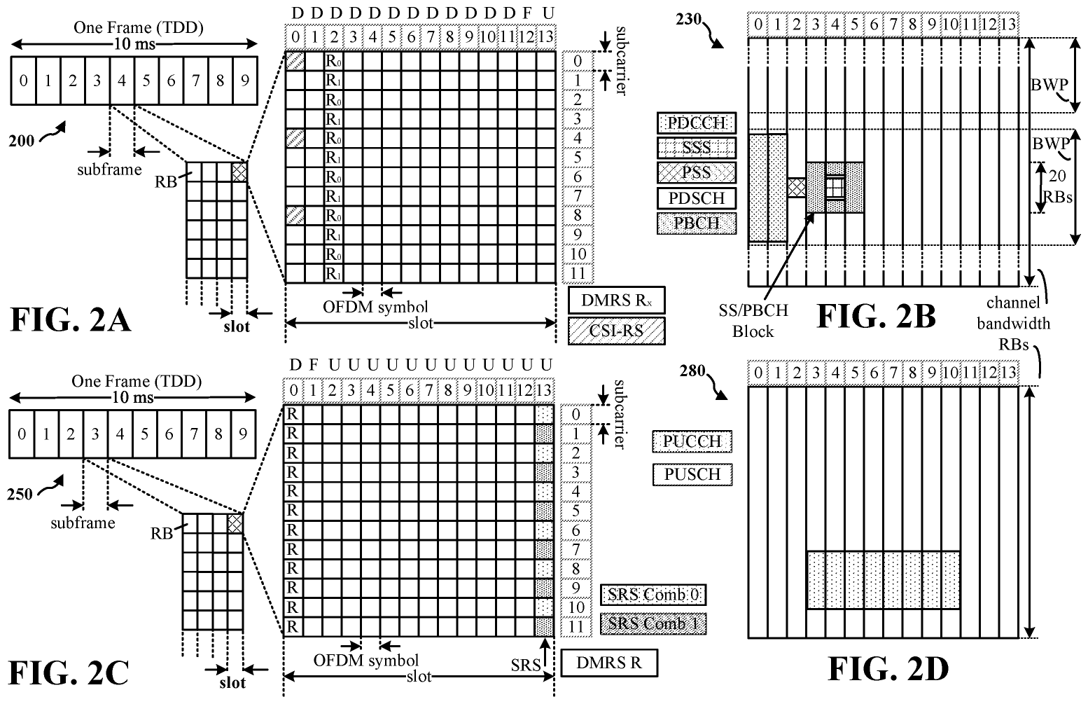

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 2\hat{ }μ*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE may determine a physical cell identifier (PCI). Based on the PCI, the UE may determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data and may additionally be used to carry a buffer status report (BSR), a power headroom report (PHR), and/or UCI.

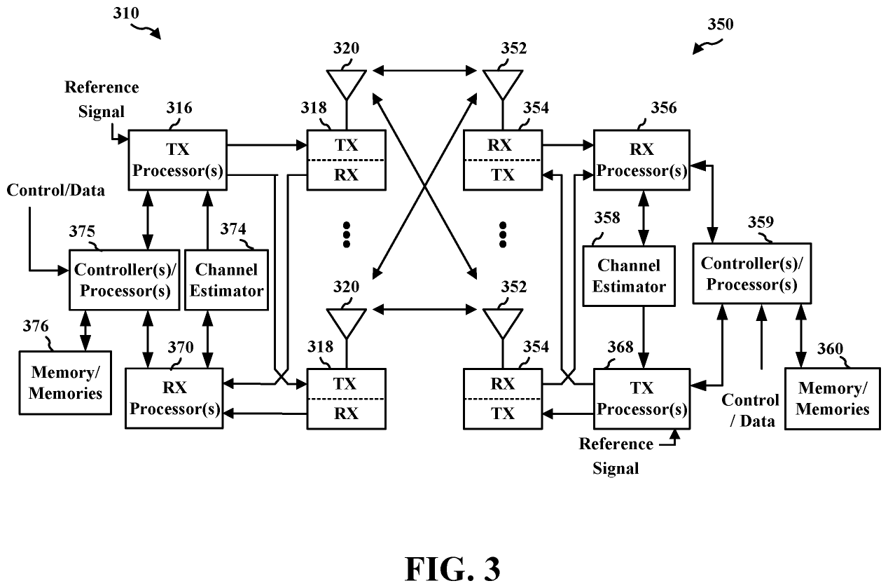

FIG. 3 is a block diagram of a first wireless device 310 in communication with a second wireless device 350 in an access network. In one example, first wireless device 310 may be an aggregated base station such as base station 102/180, or a component of a disaggregated base station, such as CU 183 or DU 185, and second wireless device 350 may be a UE 104. IP packets from the EPC 160 may be provided to one or more controllers/processors 375. The one or more controllers/processors 375 implement layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The one or more controllers/processors 375 provide RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer protocol data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The one or more transmit (TX) processors 316 and the one or more receive (RX) processors 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The one or more TX processors 316 handle mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the second wireless device 350. Each spatial stream may then be provided to a different antenna 320 via a separate transmitter 318TX. Each transmitter 318TX may modulate an RF carrier with a respective spatial stream for transmission.

At the second wireless device 350, each receiver 354RX receives a signal through its respective antenna 352. Each receiver 354RX recovers information modulated onto an RF carrier and provides the information to the one or more receive (RX) processors 356. The one or more TX processors 368 and the one or more RX processors 356 implement layer 1 functionality associated with various signal processing functions. The one or more RX processors 356 may perform spatial processing on the information to recover any spatial streams destined for the second wireless device 350. If multiple spatial streams are destined for the second wireless device 350, they may be combined by the one or more RX processors 356 into a single OFDM symbol stream. The one or more RX processors 356 then convert the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the first wireless device 310. These soft decisions may be based on channel estimates computed by the channel estimator 358. The soft decisions are then decoded and deinterleaved to recover the data and control signals that were originally transmitted by the first wireless device 310 on the physical channel. The data and control signals are then provided to the one or more controllers/processors 359, which implement layer 3 and layer 2 functionality.

The one or more controllers/processors 359 may each be associated with one or more memories 360 that store program codes and data. The one or more memories 360, individually or in any combination, may be referred to as a computer-readable medium. The one or more controllers/processors 359 provide demultiplexing between transport and logical channels, packet reassembly, deciphering, header decompression, and control signal processing to recover IP packets from the EPC 160. The one or more controllers/processors 359 are also responsible for error detection using an ACK and/or NACK protocol to support HARQ operations.

Similar to the functionality described in connection with transmission by the first wireless device 310, the one or more controllers/processors 359 provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the first wireless device 310 may be used by the one or more TX processors 368 to select the appropriate coding and modulation schemes, and to facilitate spatial processing. The spatial streams generated by the one or more TX processors 368 may be provided to different antenna 352 via separate transmitters 354TX. Each transmitter 354TX may modulate an RF carrier with a respective spatial stream for transmission.

The transmission is processed at the first wireless device 310 in a manner similar to that described in connection with the receiver function at the second wireless device 350. Each receiver 318RX receives a signal through its respective antenna 320. Each receiver 318RX recovers information modulated onto an RF carrier and provides the information to one or more RX processors 370.

The one or more controllers/processors 375 may each be associated with one or more memories 376 that store program codes and data. The one or more memories 376, individually or in any combination, may be referred to as a computer-readable medium. The one or more controllers/processors 375 provide demultiplexing between transport and logical channels, packet reassembly, deciphering, header decompression, control signal processing to recover IP packets from the second wireless device 350. IP packets from the one or more controllers/processors 375 may be provided to the EPC 160. The one or more controllers/processors 375 are also responsible for error detection using an ACK and/or NACK protocol to support HARQ operations.

At least one of the one or more TX processors 316, 368, the one or more RX processors 356, 370, and the one or more controllers/processors 359, 375, may be configured to perform aspects in connection with partial CBG component 198 of FIG. 1A.

Link adaptation is a process that adjusts the data rate and modulation scheme of a wireless link to match the channel conditions, thereby optimizing the performance of the wireless communication system. In the context of NR technology, this adaptation process is primarily based on channel state feedback (CSF) reports (also referred to interchangeably as channel state information (CSI) reports). These CSF reports are transmitted from the UE to a network entity such as a base station to provide the base station with information about the channel conditions as perceived by the UE. This information is important for the gNB to make informed decisions about link adaptation. One key aspect of these CSF reports is the recommendation of a Modulation and Coding Scheme (MCS) by the UE. The MCS is a parameter that determines the data rate and reliability of the wireless link. The UE selects this MCS in such a way that the expected Block Error Rate (BLER) for a first transmission following a CSF report aligns with a pre-set target BLER. The BLER is a measure of the error rate in the transmission of data blocks over the wireless link. Typically, but not always, this target BLER is set at 10%, which means that the system aims for a situation where no more than 10% of the transmitted data blocks are expected to contain errors after the first transmission. However, the exact target BLER can vary depending on the specific requirements of the wireless communication system.

Another key aspect of wireless communication systems are Code Block Groups (CBGs). A CBG is a group of code blocks (CBs) or units of data that are encoded for transmission over a wireless link. CBGs may be defined units for which an acknowledgement (ACK) or negative acknowledgement (NACK) (ACK/NACK) report may be provided. For instance, a UE or base station may transmit an ACK or a NACK for each successfully or unsuccessfully received CBG in an ACK/NACK report. ACK/NACK reports are important in wireless communication as they allow a receiver to confirm the successful receipt of data (ACK) or to indicate that the data was not correctly received and needs to be retransmitted (NACK). The size of these CBGs can vary significantly. At its smallest, a CBG may consist of a single CB. On the other end of the spectrum, a CBG may encompass an entire transport block (TB). A TB is a unit of data comprised of one or more CBs that is transmitted over the wireless link within a specific time interval, such as a slot. For instance, a transport block may contain multiple code blocks, depending on the size of the data and the conditions of the wireless link. The flexibility in the size of a CBG, ranging from one code block to an entire transport block, allows ACK/NACK reporting to be adapted to the specific requirements of the wireless communication system and the conditions of the wireless link, thereby optimizing the performance and reliability of the system.

In the current link adaptation process (referred to throughout this disclosure as full CBG-based link adaptation), when a wireless device fails to receive a CBG due to an error in one or more transmitted data blocks or CBs in the CBG, the device transmits an ACK/NACK report indicating a NACK for that CBG, and the entire CBG is re-transmitted. However, as re-transmission of the entire CBG occurs even in scenarios where only a portion of that CBG failed, such as due to an error in one or more (but not all) of the CBs in a CBG, reduced throughput and resource utilization efficiency may thereby result. Accordingly, to improve expected throughput in comparison to the full CBG-based link adaptation method, aspects of the present disclosure provide a minor enhancement to CSF reporting, ACK/NACK reporting, or uplink control information (UCI) reporting, which changes the transmitter's response to an ACK/NACK report indicating a failed CBG. In particular, a receiver may calculate a portion of a CBG for re-transmissions based at least in part on a current target BLER, and the receiver may indicate this partial CBG in the CSF report, ACK/NACK report, or UCI. When a transmitter receives a report indicating a failed CBG from a receiver, instead of re-transmitting previous data in the full CBG, the transmitter may re-transmit previous data in only the indicated partial CBG, with new or additional data being transmitted in the remainder of the CBG. This improved link adaptation technique may be applied for both downlink and uplink directions of communication, including scenarios where the transmitter is a base station and the receiver is the UE (downlink) and scenarios where the transmitter is the UE and the receiver is the base station (uplink). Moreover, as this technique is defined per CBG, it may be scalable for all sizes of CBGs ranging from a single CB to a full TB, thereby allowing for adaptation to different data sizes and channel conditions to optimize the performance of the wireless communication system. Furthermore, this improved link adaptation scheme may increase the capacity of the wireless communication system without compromising Quality of Service (QOS), since the scheme does not introduce any additional delay compared to the full CBG re-transmission approach.

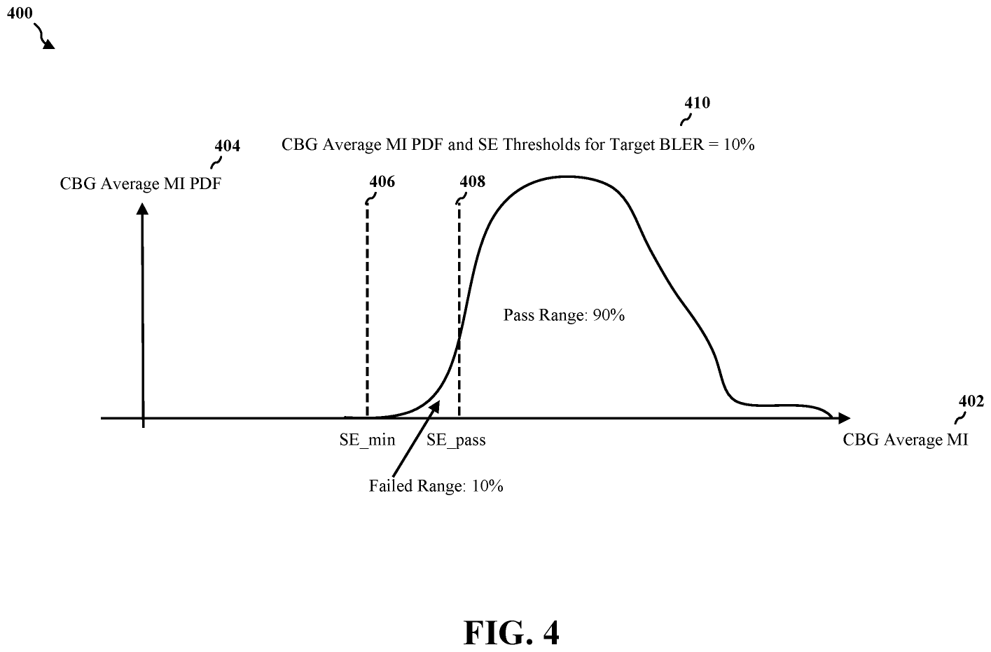

FIG. 4 illustrates an example 400 of data that a receiver may utilize to calculate a partial CBG in a partial CBG-based link adaptation scheme. The receiver may initially utilize a history of received slots to calculate average mutual information (MI 402) per slot. Generally, MI refers to a statistical measure that quantifies an amount of information that may be obtained about one random variable by observing another variable, such as information obtained regarding received data by observing transmitted data. For example, the MI 402 obtained in FIG. 4 may be a number of bits per resource element or other metric representing an average spectral efficiency (SE) observed from the history of received slots at the receiver from transmitted data, or the MI 402 may be some other reliable metric for predicting the success or failure of CBGs. In this example, the receiver may average the MI 402 obtained from CBG transmissions over an entire slot or multiple slots, rather than obtained from each CBG separately, to obtain a more accurate, long-term statistical estimate of wireless system performance. Once the receiver calculates the average MI 402 per slot(s), the receiver may create a histogram or other graphical representation of the distribution of this data such as illustrated in FIG. 4. For instance, the receiver may generate a probability distribution function (PDF) of the average MI values observed from CBGs over time, such as a distribution 404 of the average SE observed from received CBGs over a historical window of one or more slots. Alternatively, the receiver may generate some other distribution or visual representation of system performance from observed MI 402 in CBGs over time.

Then using this histogram or other calculated distribution 404 of the data, the receiver may calculate two SE thresholds 406, 408, or other thresholds if a different metric than SE is represented by the MI 402, based on a target BLER 410. The first threshold 406, referred to in this example as SE_min, a minimum SE threshold, or a minimum MI threshold generally, is an MI threshold below which 0% of slots or CBGs failed reception during the observed period of time. For instance, in the example of FIG. 4, SE_min may represent the minimum amount of SE, or other metric represented by the MI 402, that is observed from CBGs transmitted over a certain period of time regardless of target BLER 410 or errors in data blocks. The second threshold 408, referred to in this example as SE_pass, a passing SE threshold, or a passing MI threshold generally, is a MI threshold below which a percentage of slots or CBGs equal to the target BLER 410 failed reception during the observed period of time. For instance, in the example of FIG. 4, SE_pass may represent the passing SE, or other metric represented by the MI 402, at which point system performance is observed to meet or have a lower error rate than the target BLER 410. For instance, when the target BLER=10%, SE_pass may correspond to the SE where 90% of CBGs passed reception or were received without errors in observed slot(s) while 10% of CBGs failed reception or were received with error(s) in observed slot(s).

Following obtaining of the MI thresholds 406, 408 such as SE_pass and SE_min, the receiver calculates the partial CBG for re-transmission using these thresholds. For instance, the receiver may apply the following formula (1) for calculating the partial CBG:

$$partial\_CBG = ( SE\_pass - SE\_min ) / SE\_min \qquad ( 1 )$$

The numerator in this formula, SE_pass−SE_min, may represent the range of SE or MI 402 that was lacking for successful CBG reception or which led to failed reception of the CBG. The denominator in this formula, SE_min, may be applied to normalize the SE_pass−SE_min range to a common scale, such as a value between zero and one. Thus, when the receiver provides an ACK/NACK report indicating a NACK for a CBG (due to the failed reception), the range SE_pass−SE_min after dividing by SE_min may correspond to the portion of the CBG that the receiver did not receive and thus intends to be re-transmitted. In this example, SE_min is applied as the denominator for normalization purposes, rather than SE_pass, since the resulting partial CBG would be larger and thus provide a more conservative approach for re-transmission. For example, this approach may prevent the transmitter from re-transmitting less data than what the receiver may actually need from the re-transmission. However, in other examples, SE_pass may be alternatively applied as the denominator in less conservative approaches.

After calculating the partial CBG, which may be a fraction within a range [0, 1] using the previously described formula (1), the receiver may send this value to the transmitter according to one of multiple approaches. In a first approach, the receiver may provide the partial CBG at the time it sends an ACK/NACK report indicating NACKs for failed CBGs and ACKs for passed CBGs. More particularly, in response to a failed CBG reception, the receiver may ‘piggyback’ or append the calculated partial CBG to the NACK for that CBG in the ACK/NACK report. For example, the UE or base station may send a fraction representing the partial CBG in the ACK/NACK report via a plurality of bits indicating a quantity corresponding to this fraction, such as a partial CBG of 0/16, 1/16, 2/16, . . . , or 15/16 using 4 bits via quantities ‘0000’, ‘0001’, ‘0010’, . . . , or ‘1111’ respectively. Alternatively, a different granularity for the partial CBG (such as 3 bits corresponding to 0/8, . . . 7/8) may be applied instead. These partial CBG bits may be added to the report when a NACK bit is sent for at least one failed CBG in a slot.

In a second approach, the receiver may provide the partial CBG in a CSF report, rather than the ACK/NACK report. For instance, the UE or base station may ‘piggyback’ or append the calculated partial CBG to CSI in a CSF report when it periodically provides information regarding channel conditions. In a third approach, the receiver may provide the partial CBG in UCI. For instance, the UE may ‘piggyback’ or append the calculated partial CBG to control information in UCI to the base station. In these two approaches, the partial CBG bits may be added to CSF reports or UCI similarly to ACK/NACK reports, but unlike ACK/NACK reports where these partial CBG bits may be transmitted multiple times (e.g., one in each ACK/NACK report in response to respective CBG transmissions), here the partial CBG bits may be transmitted less frequently (e.g., once in the CSF report or UCI). Thus, the CSF and UCI approaches may save overhead compared to the ACK/NACK approach for providing partial CBGs, since CSF reports and UCI may be transmitted at a lower rate than ACK/NACK reports. Such reporting in CSF or UCI may also be efficient given the partial CBG's calculation from long-term statistics of CBG MI in previously received slot(s) such as illustrated in FIG. 4. On the other hand, the ACK/NACK approach may more frequently allow the receiver to recalculate and report a partial CBG in response to each transport block, thus providing a more dynamic approach to calculation and reporting of partial CBGs than in the CSF and UCI approaches.

After the transmitter receives the partial CBG from the receiver in one of the aforementioned approaches, the transmitter may utilize this partial CBG at the time of re-transmission. For instance, the transmitter may send a subsequent transmission of unsuccessfully received data in only the indicated portion of the CBG, rather than unsuccessfully and successfully received data again in the entire CBG. In this way, the re-transmission process may be optimized, since only the applicable portion of the CBG is retransmitted with old data, rather than the full CBG. Instead, the remaining portion of the CBG may be utilized for new data, leading to improved throughput and efficiency.

Thus, the partial CBG-based link adaptation scheme of the present disclosure may optimize the use of CBGs in a wireless communication system. This optimization may be based on an observation that the SE gap for passing is less than the difference between SE_pass and SE_min in the histogram or other visual representation of the distribution 404 of the average MI of the CBG in FIG. 4. For example, from this representation, it may be seen that if an entire CBG was required to pass SE_pass bits, then only a fraction of the CBG or the partial CBG may be needed for the additional (SE_pass−SE_min) bits. As the SE gap for passing is less than (SE_pass−SE_min), or in other words, less data needs to be re-transmitted than initially provided, the remaining part of the CBG not needed for re-transmission may instead be utilized for a new data transmission.

Thus, aspects of the present disclosure may lead to improved throughput and network efficiency compared to other schemes in which the whole CBG is re-transmitted regardless of the SE gap, since only necessary parts of CBGs may be retransmitted while freeing up capacity in these CBGs for new data transmissions. In other schemes, if a CBG fails to be transmitted successfully, the entire CBG would be retransmitted in response to a NACK. This approach may be inefficient as it may involve retransmitting data that does not need to be retransmitted. However, in the partial CBG-based link adaptation of the present disclosure, only a fraction of the failed CBG may be retransmitted. For instance, if the calculated partial CBG was 0.3 or 30%, then only 30% of the data in the failed CBG would be retransmitted, while the remaining 70% of the CBG may be used to send new data. This partial CBG retransmission would apply to each CBG that failed reception. For example, in a scenario where the base station transmits five CBGs in a slot, two of these CBGs failed reception, and the base station receives a report from the UE of a partial CBG value corresponding to 30%, then the base station would send a new transmission of multiple CBGs where only 30% of the two failed CBGs will include retransmitted data while the remaining 70% of those two failed CBGs will be new data (the three other CBGs that fully passed reception would not be re-transmitted). This efficient use of CBGs may thus significantly enhance the performance of the wireless communication system.

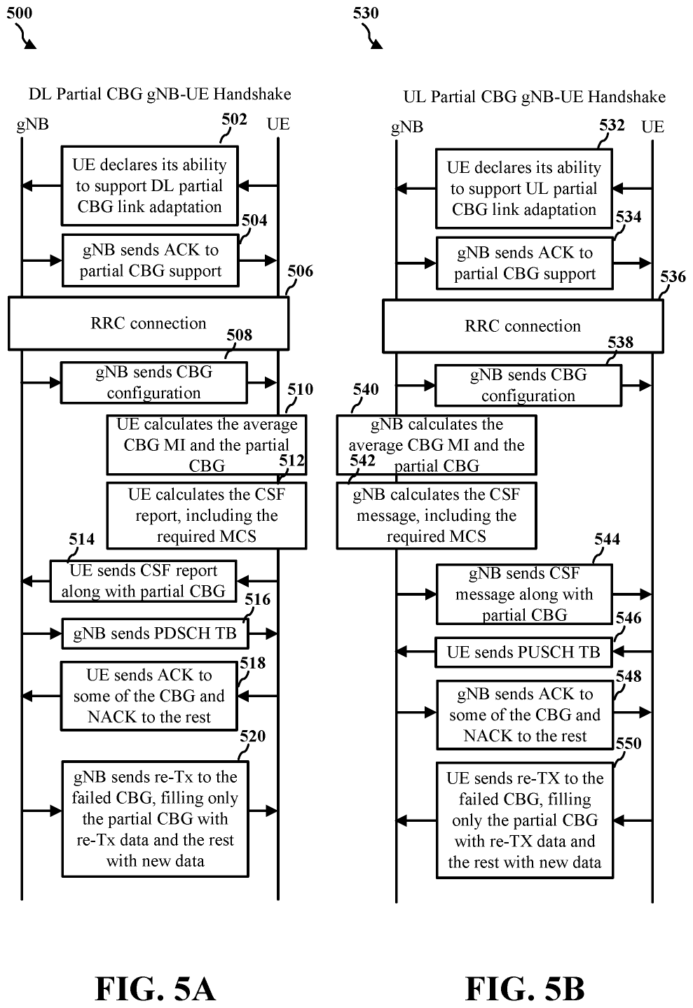

FIGS. 5A and 5B illustrate examples 500, 530 of call flow diagrams respectively depicting a handshake between a base station (BS 102/180) and a UE (UE 104) for partial CBG downlink (DL) and uplink (UL) link adaptation. More particularly, these figures illustrate the communication flow between a base station and a UE in the DL and UL adaptations respectively. While the illustrated example refers to gNB for BS 102/180, it should be understood that the example is not limited to NR/5G and may encompass other RATs such as LTE (e.g., BS 102/180 may be an eNB).

In the example 500 of DL adaptation in FIG. 5A, the process begins with the UE declaring its capability to support DL partial CBG link adaptation at block 502. For instance, the UE may send a message to the base station indicating it is capable of supporting partial CBG re-transmissions. This declaration is acknowledged by the base station at block 504, which then defines the granularity for partial CBGs in the [0, 1] range (such as 3 bits for 1/8 granularity or 4 bits for 1/16 granularity depending on a level of accuracy intended in the system). For instance, the base station may send an acknowledgement message to the UE indicating the defined granularity for partial CBGs. Afterwards, the base station establishes a RRC connection with the UE at block 506. Following the RRC connection, the base station sends a CBG configuration to the UE at block 508. The CBG configuration may specify, for example, the number of code blocks in a CBG. Upon receiving the CBG configuration, at block 510, the UE calculates the long-term, average slot MI observed from CBGs, and from this information the partial CBG, such as described with respect to FIG. 4. Subsequently, at block 512, the UE computes the CSF report, which includes the recommended MCS. This CSF report, piggybacked with the partial CBG in the illustrated example, is then sent to the base station at block 514. Alternatively, the partial CBG may be sent in an ACK/NACK report (below) or in periodic UCI in other examples. The base station, in response, sends a PDSCH TB to the UE at block 516. Depending on which CBGs succeeded in reception or failed in reception, the UE then sends acknowledgements (ACKs) to some of the CBGs and negative acknowledgements (NACKs) to others at block 518. The UE may also send the partial CBG along with this ACK/NACK report to the base station in some examples. The gNB responds to the NACKs at block 520 by re-transmitting data in each of the failed CBGs, filling only the partial CBG with re-transmission data and the rest of the CBG with new data.

Similarly, in the example 530 of UL adaptation in FIG. 5B, a similar process is followed but with the roles of the base station and UE reversed. For instance, similar to FIG. 5A, the UE declares its ability to support UL partial CBG link adaptation at block 532, which is acknowledged by the base station with the partial CBG granularity at block 534. However, once the RRC connection is established at block 536 and the CBG configuration is sent by the base station at block 538, in the UL example it is the base station at block 540 that calculates the long-term, average slot MI observed from CBGs, and from this information the partial CBG, such as described with respect to FIG. 4. The base station also computes the CSF message at block 542, which includes the MCS, and sends it along with the partial CBG in the illustrated example to the UE at block 544. Alternatively, the partial CBG may be sent in an ACK/NACK report (below) in other examples. The UE then sends a PUSCH TB to the base station at block 546. Depending on which CBGs succeeded in reception or failed in reception, the base station sends ACKs to some of the CBGs and NACKs to others at block 548. The base station may also send the partial CBG along with this ACK/NACK report to the UE in some examples. The UE responds to the NACKs at block 550 by re-transmitting data in each of the failed CBGs, filling only the partial CBG with re-transmission data and the rest of the CBG with new data.

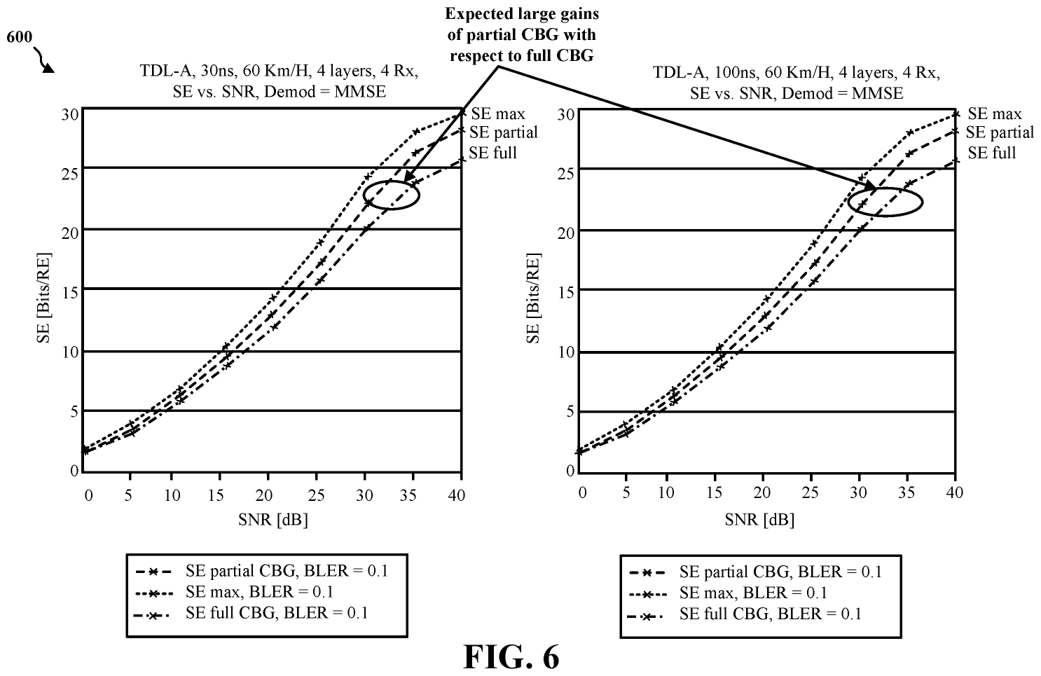

FIG. 6 illustrates examples 600 of simulations performed to validate the partial CBG link adaptation method of the present disclosure. In these examples, the two simulation scenarios included the following parameters—channel: TDL A; delay spread: 30 ns (left chart) and 100 ns (right chart); data rate: 60 kilometer (Km) per hour (H); layers: 4 (transmission and reception); CBG size—the full TB; precoding: random; BLER target=10%, demodulator: Minimum Mean Square Error (MMSE), number of slots: 100. In the simulations, MMSE demodulation was performed on received data and the average MI over the entire TB was calculated over the number of slots. Expected SE curves of the partial CBG, full CBG, and the upper bound (the maximum achievable SE) were then generated using the following equations:

$$S {E}_{p a rtial CBG} = \frac{S {E}_{p a s s}}{1 + \frac{{N}_{F a i l e d}}{N} \cdot \frac{( {SE}_{p a s s} - {SE}_{min} )}{{SE}_{m t n}}} ,$$

$${SE}_{full CBG} = \frac{S {E}_{p a s s}}{1 + \frac{{N}_{F a i l e d}}{N}} ,$$

$${SE}_{max} = \frac{1}{N} {\sum }_{i = 1}^{N} {MI}_{i} ,$$

where N is the number of slots, NFailed is the number of failed slots, and MIᵢ is the average MI of the i'th slot. The illustrated results show significant gain in throughput of partial CBG-based link adaptation compared to the full CBG link adaptation method. For instance, both charts show that while the partial CBG curve did not reach the upper bound, it still managed to compensate for most of the loss of the full CBG link curve from the upper bound curve. This illustrates the effectiveness of the partial CBG-based link adaptation method in improving the efficiency of the full CBG-based link adaptation process without causing additional delay or other penalty in quality of service.

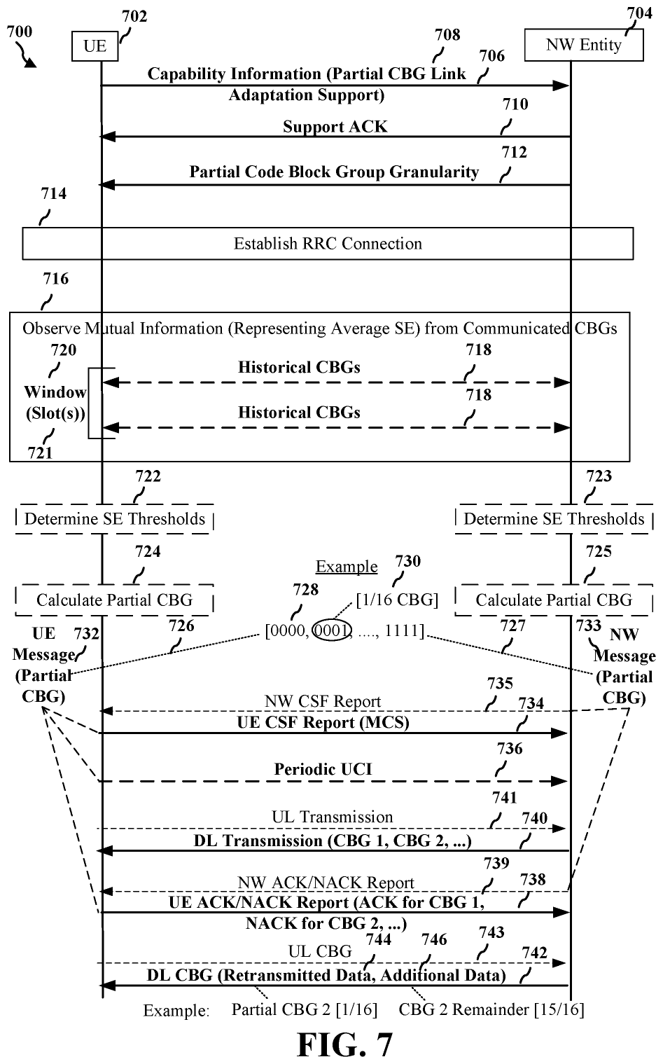

FIG. 7 illustrates an example 700 of a call flow diagram between a UE 702, such as UE 104 or wireless device 350, and a network entity 704, such as aggregated base station 102/180, disaggregated base station 181, or one or more of the components of disaggregated base station 181. Initially, the UE may transmit capability information 706 indicating partial CBG link adaptation support 708 to the network entity. For example, referring to FIGS. 5A-5B, at block 502, 532, the UE may send a message to the base station indicating the UE is capable of supporting partial CBG re-transmissions. In response, the network entity may transmit a support ACK 710 to the UE acknowledging the UE's indicated capability information 706 or support 708. The network entity may also transmit to the UE an indication of a granularity 712 for the partial CBG. For example, referring to FIGS. 5A-5B, the base station may send an acknowledgement message to the UE at block 504, 534 indicating the defined granularity for partial CBGs. The base station may define the granularity for partial CBGs in the [0, 1] range, such as 3 bits for 1/8 granularity or 4 bits for 1/16 granularity depending on a level of accuracy intended in the system. Afterwards, the UE and network entity may establish an RRC connection 714. For instance, referring to FIGS. 5A-5B, the UE and base station may at block 506 establish the RRC connection.

Following the RRC connection 714, the UE and base station may observe mutual information 716, such as MI representing an average SE of the communication link, from communicated CBGs 718 transmitted or received in a historical window 720 of one or more slots 721. For example, referring to FIGS. 5A-5B and as described with respect to FIG. 4, at block 510 (for DL adaptation) or block 540 (for UL adaptation), the UE or base station may calculate the long-term, distribution 404 of average slot MI 402 observed from previously received or transmitted CBGs. Then, depending on whether DL or UL partial CBG link adaptation is applied, either the UE or the base station (whichever is the receiver for DL or UL) may determine SE thresholds at block 722 (for DL) or block 723 (for UL) from the observed MI. For example, referring to FIGS. 5A-5B and as described with respect to FIG. 4, at block 510 (for DL adaptation) or block 540 (for UL adaptation), the receiver may calculate two SE thresholds 406, 408 (SE_min and SE_pass) based on the target BLER 410. Upon determining the SE thresholds, the UE or base station may calculate the partial CBG at block 724 (for DL) or block 725 (for UL), which partial CBG 726, 727 may correspond to a quantity 728 representing a fraction 730 of a CBG. For example, referring to FIGS. 4 and 5A-5B, at block 510 (for DL adaptation) or block 540 (for UL adaptation), the receiver may calculate the partial CBG for re-transmission as a function of the two SE thresholds 406, 408 using the aforementioned formula (1).

The UE may then send this partial CBG 726 in a message 732 to the network entity for DL adaptation, or the network entity may send this partial CBG 727 in a message 733 to the UE for UL adaptation. For instance, in the DL scenario, the UE may transmit the message 732 with the partial CBG 726 in a CSF report 734 recommending a particular MCS, in periodic UCI 736, or in an ACK/NACK report 738 responsive to a DL transmission 740 from the network entity. For example, referring to FIG. 5A, the UE may ‘piggyback’ or append the calculated partial CBG to the CSF report at block 514, to a NACK for a CBG in the ACK/NACK report at block 518, or to UCI. Likewise, in the UL scenario, the network entity may transmit the message 733 with the partial CBG 727 in a CSF report 735 indicating the particular MCS, or in an ACK/NACK report 739 responsive to an UL transmission 741 from the UE. For example, referring to FIG. 5B, the base station may ‘piggyback’ or append the calculated partial CBG to the CSF report at block 544, or to a NACK for a CBG in the ACK/NACK report at block 548.

The ACK/NACK report 738, 739 may include an ACK or NACK for each CBG that is successfully or unsuccessfully received respectively in the DL or UL transmission 740, 741. Thus, in either the DL or UL scenario, when the transmitter receives a NACK for any CBG from the receiver, the transmitter sends a subsequent CBG 742, 743 including retransmitted data 744 in the previously indicated, partial CBG 726, 727, and additional data 746 in the remainder of the CBG 742, 743. For example, referring to FIGS. 5A-5B, at block 520 (for DL adaptation) or block 550 (for UL adaptation), the base station or UE may send a subsequent transmission of unsuccessfully received data in only the indicated portion of the CBG, rather than unsuccessfully and successfully received data again in the full CBG. Thus, in the illustrated DL example of FIG. 7 where the UE sends a NACK for CBG 2 of the DL transmission 740 from the network entity, and the partial CBG 726 was previously reported as 1/16, the network entity may re-transmit data 744 from CBG 2 in 1/16 of the subsequent DL CBG 742 and new data 746 in the remaining 15/16 of the subsequent DL CBG 742. Similarly, in the illustrated UL example of FIG. 7 where the network entity sends a NACK for CBG 2 of the UL transmission 741 from the UE, and the partial CBG 727 was previously reported as 1/16, the UE may re-transmit data from CBG 2 in 1/16 of the subsequent UL CBG 743 and new data in the remaining 15/16 of the subsequent UL CBG 743. As a result, throughput and efficiency may be improved compared to the full CBG scheme.

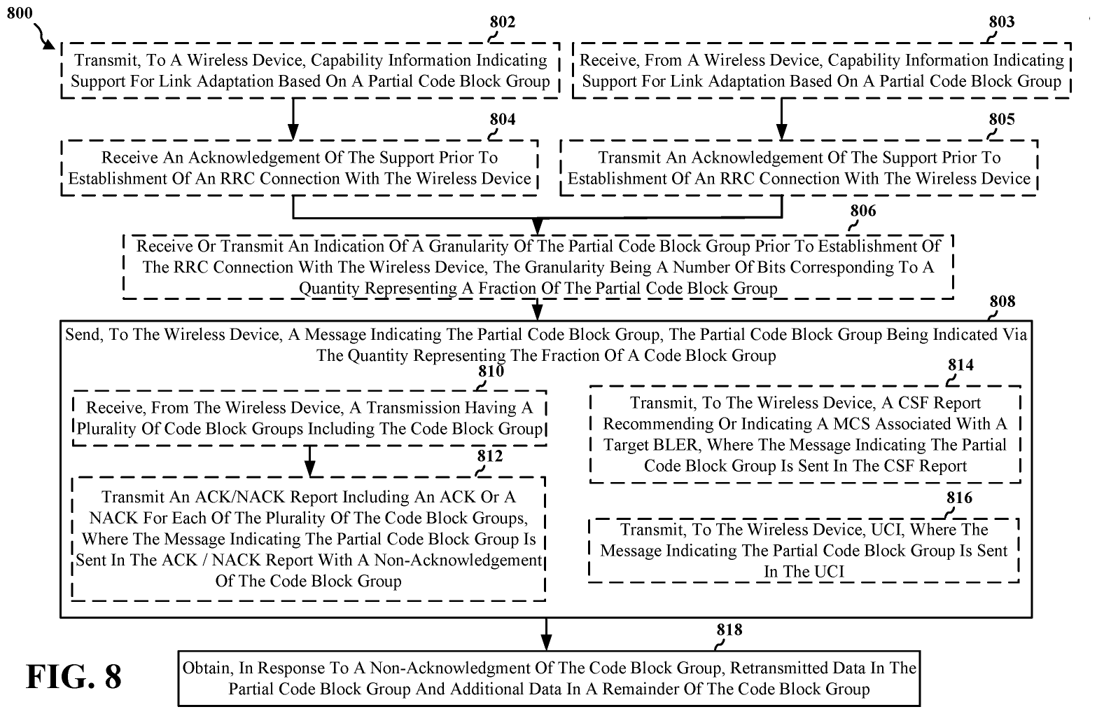

FIG. 8 is a flowchart 800 of an example method or process for wireless communication performable at a first wireless device. Optional aspects are illustrated in dashed lines. The method may be performed by a UE for DL partial CBG link adaptation, or by a network entity for UL partial CBG link adaptation. For example, the method may be performed by UE 104, base station 102/180, disaggregated base station 181, wireless device 310, 350, UE 702, network entity 704, or the apparatus 902 or its components as described herein.

In one example where the first wireless device is a UE, at block 802, the first wireless device may transmit, to a second wireless device, capability information indicating support for link adaptation based on a partial code block group. For example, block 802 may be performed by transmission component 934. For instance, referring to FIG. 7, the UE may send a message to the base station indicating it is capable of supporting partial CBG re-transmissions. In one example, the first wireless device may transmit capability information 706 indicating partial CBG link adaptation support 708 to the network entity. This transmission may be performed by the TX processor(s) 368 in the wireless device 350 as described in FIG. 3, which provide layer 1 functionality such as for example handling mapping to signal constellations and producing a physical channel carrying a time domain OFDM symbol stream. Afterwards, at block 804, the first wireless device may receive an acknowledgement of the support prior to establishment of an RRC connection with the second wireless device. For example, block 804 may be performed by reception component 930. For instance, referring to FIG. 7, the UE may receive support ACK 710 from the network entity acknowledging the UE's indicated capability information 706 or support 708. This reception can be performed by the RX processor(s) 356 in the wireless device 350 as described in FIG. 3, which provide layer 1 functionality such as for example recovering information modulated onto an RF carrier and converting the OFDM symbol stream from the time-domain to the frequency domain.

In another example where the first wireless device is a network entity, at block 803, the first wireless device may receive, from a second wireless device, capability information indicating support for link adaptation based on a partial code block group. For example, block 803 may be performed by reception component 930. For instance, referring to FIG. 7, the network entity may receive a message from the UE indicating it is capable of supporting partial CBG re-transmissions. In one example, the first wireless device may receive capability information 706 indicating partial CBG link adaptation support 708 from the UE. This reception can be performed by the RX processor(s) 370 in wireless device 310 as described in FIG. 3, which provide layer 1 functionality similar to RX processor(s) 356. Afterwards, at block 805, the first wireless device may transmit an acknowledgement of the support prior to establishment of an RRC connection with the second wireless device. For example, block 804 may be performed by transmission component 934. For instance, referring to FIG. 7, the network entity may transmit support ACK 710 to the UE acknowledging the UE's indicated capability information 706 or support 708. This transmission may be performed by the TX processor(s) 316 in the wireless device 310 as described in FIG. 3, which provide layer 1 functionality similar to TX processor(s) 368.

At block 806, following the operations of blocks 802 and 804 (if the first wireless device is a UE) or the operations of blocks 803 and 805 (if the first wireless device is a network entity), in one example, the first wireless device may receive (if UE) or transmit (if network entity) an indication of a granularity of the partial code block group prior to establishment of the RRC connection with the second wireless device. For example, block 806 may be performed by reception component 930 when the first wireless device is a UE, or by transmission component 934 when the first wireless device is a network entity. The granularity may be a number of bits corresponding to a quantity representing a fraction of the partial code block group. For instance, referring to FIG. 7, the network entity may transmit a message to the UE indicating the defined granularity 712 for partial CBGs. In one example, to receive the indication of the granularity, the UE may receive support ACK 710 from the base station indicating the defined granularity for partial CBGs. This reception can be performed by the RX processor(s) 356 in the wireless device 350 as described in FIG. 3. In another example, to transmit the indication of the granularity, the network entity may transmit support ACK 710 to the UE indicating the defined granularity for partial CBGs. This transmission may be performed by the TX processor(s) 316 in the wireless device 310 as described in FIG. 3.

Then at block 808, the first wireless device may send, to the second wireless device, a message indicating the partial code block group, the partial code block group being indicated via the quantity representing the fraction of a code block group. For example, block 808 may be performed by message component 940. For instance, referring to FIG. 7, if the first wireless device is a UE, it may send message 732 to the network entity indicating the partial CBG 726. If the first wireless device is a network entity, it may send message 733 to the UE indicating the partial CBG 727. The partial CBG 726, 727 may be indicated via quantity 728 representing fraction 730 of a CBG. In one example, the first wireless device may send this message after the establishment of the RRC connection between the first wireless device and the second wireless device. This sending operation may be performed by the controller/processor(s) 359 in the wireless device 350 or the controller/processor(s) 375 in the wireless device 310 as described in FIG. 3, which for example provide layer 2 and 3 functionality such as mapping between logical channels and transport channels and multiplexing of MAC SDUs onto transport blocks, and which communicate with the TX processor(s) 316 in the wireless device 310 or the TX processor(s) 368 in the wireless device 350 to handle layer 1 functionality transmission of the message indicating the partial code block group.

In one example, the partial code block group may be based on mutual information between the apparatus and the wireless device which is observed from code block groups transmitted or received in a historical window of one or more slots. For instance, referring to FIGS. 4 and 7, the receiver may initially utilize a history of received slot(s) 721 in window 720 to calculate average mutual information (MI 402) per slot of historical CBGs 718. In one example, the mutual information may represent an average spectral efficiency observed in the historical window. For instance, referring to FIG. 4, the MI 402 may be a number of bits per resource element or other metric representing an average SE observed from the history of received slots at the receiver from transmitted data. In one example, the partial code block group may be based on a first SE threshold and a second SE threshold corresponding to a target BLER, where the first SE threshold corresponds to a minimum amount of spectral efficiency observed from code block groups transmitted or received in a historical window of one or more slots, and where the second SE threshold corresponds to an amount of spectral efficiency under which a percentage of the one or more slots or the code block groups, equal to the target BLER, experienced reception failure during the historical window. For instance, referring to FIG. 4, the receiver may calculate two SE thresholds 406, 408 (or other thresholds if a different metric than SE is represented by the MI 402) based on a target BLER 410, where the first SE threshold (SE_min) corresponds to the minimum amount of SE observed from historical CBGs 718 in the window 720 of slot(s) 721, and where the second SE threshold (SE_pass) corresponds to the amount of SE under which 10% (or other target BLER) of the slot(s) 721 or CBGs 718 failed reception in window 720 such as illustrated in FIG. 4. In one example, the quantity indicating the partial code block group is a function of the first SE threshold and a difference between the second SE threshold and the first SE threshold. For instance, referring to FIGS. 4 and 7, the receiver may calculate the quantity 728 or fraction 730 indicating partial CBG 726, 727 using these thresholds 406, 408 in the aforementioned formula (1): partial_CBG=(SE_pass−SE_min)/SE_min.

Blocks 810 and 812 refer to one example of sending the message at block 808. In particular, at block 810, the first wireless device may receive, from the second wireless device, a transmission having a plurality of code block groups including the code block group. For example, block 810 may be performed by reception component 930. For instance, referring to FIG. 7, if the first wireless device is a UE, it may receive a PDSCH TB (block 516) such as DL transmission 740 including CBG 1, 2, etc. from the network entity. If the first wireless device is a network entity, it may receive a PUSCH TB (block 546) such as UL transmission 741 including CBG 1, 2, etc. from the UE. In one example, the first wireless device may receive this transmission, which reception may be performed by the RX processor(s) 356 in the wireless device 350 or the RX processor(s) 370 in the wireless device 310 performing layer 1 functionality as described in FIG. 3. Then at block 812, the first wireless device may transmit an ACK/NACK report including an ACK or a NACK for each of the plurality of the code block groups, where the message indicating the partial code block group is sent in the ACK/NACK report with a non-acknowledgement of the code block group. For example, block 812 may be performed by transmission component 934. For instance, referring to FIG. 7, if the first wireless device is a UE, it may transmit ACK/NACK report 738 (block 518) to the network entity including an ACK for CBG 1, a NACK for CBG 2, etc. along with the partial CBG 726. If the first wireless device is a network entity, it may transmit ACK/NACK report 739 (block 548) to the UE including an ACK for CBG 1, a NACK for CBG 2, etc. along with the partial CBG 727. In one example, transmitting the ACK/NACK report may include the controller/processor(s) 359 in the wireless device 350 or the controller/processor(s) 375 in the wireless device 310 providing the partial CBG and ACKs/NACKs to the TX processor(s), which TX processor(s) 316 in the wireless device 310 or which TX processor(s) 368 in the wireless device 350 then perform layer 1 functionality transmission of the ACK/NACK report and partial CBG.

Block 814 refers to another example of sending the message at block 808. In particular, at block 814, the first wireless device may transmit, to the second wireless device, a CSF report recommending or indicating a MCS associated with a target BLER, where the message indicating the partial code block group is sent in the CSF report. For example, block 814 may be performed by transmission component 934. For instance, referring to FIG. 7, if the first wireless device is a UE, it may transmit CSF report 734 (block 514) including the partial CBG 726 as well as an MCS associated with target BLER 410 to the network entity. If the first wireless device is a network entity, it may transmit CSF report 735 (block 544) including the partial CBG 727 as well as an MCS associated with target BLER 410 to the UE. In one example, the first wireless device may transmit this CSF report, which transmission may be performed by the TX processor(s) 316 in the wireless device 310 or the TX processor(s) 368 in the wireless device 350 performing layer 1 functionality as described in FIG. 3, after the controller/processor(s) 359 in the wireless device 350 or the controller/processor(s) 375 in the wireless device 310 performing layer 2 or 3 functionality as described in FIG. 3 provide the CSF and the partial CBG to the TX processor(s) for transmission.

Block 816 refers to another example of sending the message at block 808. In particular, at block 816, the first wireless device may transmit, to the second wireless device, UCI, where the message indicating the partial code block group is sent in the UCI. For example, block 816 may be performed by transmission component 934. For instance, referring to FIG. 7, if the first wireless device is a UE, it may transmit UCI 736 to the network entity including the partial CBG 726. In one example, the first wireless device may transmit this UCI, which transmission may be performed by the TX processor(s) 368 in the wireless device 350 performing layer 1 functionality as described in FIG. 3, after the controller/processor(s) 359 in the wireless device 350 performing layer 2 or 3 functionality as described in FIG. 3 provide the partial CBG to the TX processor(s) for transmission.

Finally, at block 818, the first wireless device may obtain, in response to a non-acknowledgment of the code block group, retransmitted data in the partial code block group and additional data in a remainder of the code block group. For example, block 818 may be performed by code block group component 942. In one example, the first wireless device or apparatus is a UE, the second wireless device is a network entity, and the retransmitted data is downlink data. For instance, referring to FIG. 7, the UE may obtain retransmitted data 744 in the partial CBG 726 and additional data 746 in a remainder of the CBG 742 (block 520) responsive to a NACK for CBG 2 in ACK/NACK report 738. For example, if the partial CBG 726 indicates 1/16 of a CBG, the UE may obtain retransmitted data 744 from CBG 2 in 1/16 of CBG 742 and additional data 746 in 15/16 of CBG 742. In this example, the obtaining operation may be performed by the controller/processor(s) 359 in the wireless device 350 as described in FIG. 3, which communicate with the RX processor(s) 356 to handle reception of the data with layer 1 functionality, and which for example apply layer 2 and 3 functionality on the received data such as demultiplexing between transport and logical channels. In another example, the first wireless device or apparatus is a network entity, the second wireless device is a UE, and the retransmitted data is uplink data. For instance, referring to FIG. 7, the network entity may obtain retransmitted data in the partial CBG 727 and additional data in a remainder of the CBG 743 (block 550) responsive to a NACK for CBG 2 in ACK/NACK report 739. For example, if the partial CBG 727 indicates 1/16 of a CBG, the network entity may obtain retransmitted data 744 from CBG 2 in 1/16 of CBG 743 and additional data 746 in 15/16 of CBG 743. In this example, the obtaining operation may be performed by the controller/processor(s) 375 in the wireless device 310 as described in FIG. 3, which communicate with the RX processor(s) 370 to handle reception of the data with layer 1 functionality, and which for example apply layer 2 and 3 functionality on the received data such as demultiplexing between transport and logical channels.

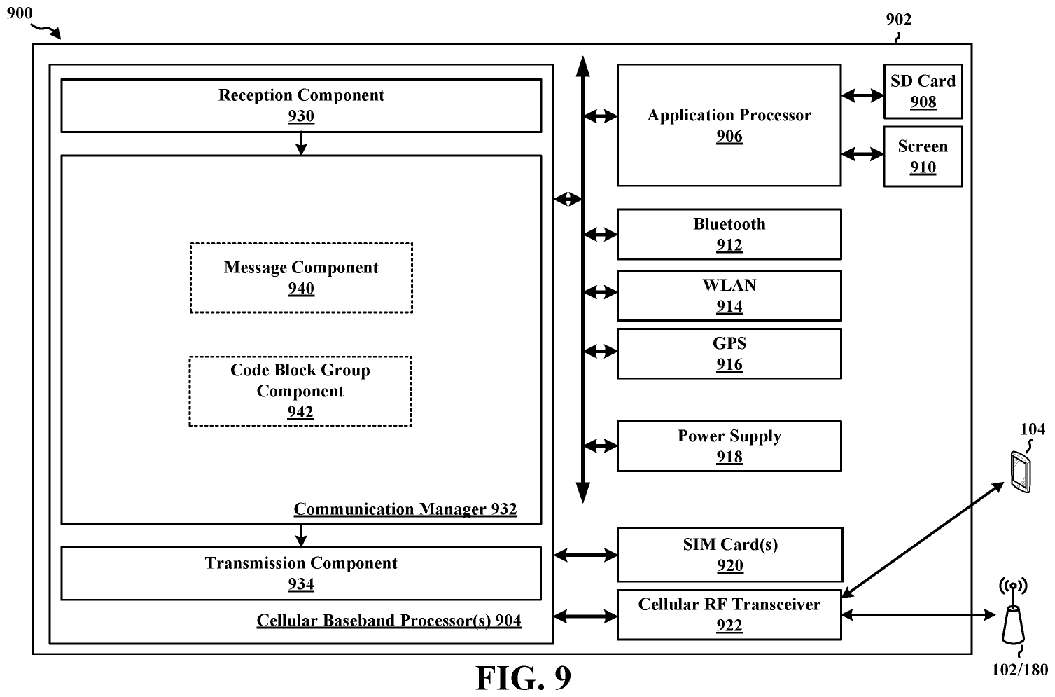

FIG. 9 is a diagram 900 illustrating an example of a hardware implementation for an apparatus 902 such as a wireless device according to the various aspects of the present disclosure. In one example, the apparatus 902 may be a UE such as UE 104, 702 and includes one or more cellular baseband processors 904 (also referred to as a modem) coupled to a cellular RF transceiver 922 and one or more subscriber identity modules (SIM) cards 920, an application processor 906 coupled to a secure digital (SD) card 908 and a screen 910, a Bluetooth module 912, a wireless local area network (WLAN) module 914, a Global Positioning System (GPS) module 916, and a power supply 918. The one or more cellular baseband processors 904 communicate through the cellular RF transceiver 922 with the UE 104 and/or BS 102. In another example, the apparatus 902 may be a base station such as base station 102/180 or one or more components of disaggregated base station 181, in which case the one or more cellular baseband processors 904 may be replaced by baseband unit(s) (not shown), and in which case one or more illustrated components of FIG. 9 coupled to the baseband unit(s) may be omitted.

The one or more cellular baseband processors 904 or baseband units may each include a computer-readable medium/one or more memories. The computer-readable medium/one or more memories may be non-transitory. The one or more cellular baseband processors 904 or baseband units are responsible for general processing, including the execution of software stored on the computer-readable medium/one or more memories individually or in combination. The software, when executed by the one or more cellular baseband processors 904 or baseband units, causes the one or more cellular baseband processors 904 or baseband units to, individually or in combination, perform the various functions described supra. The computer-readable medium/one or more memories may also be used individually or in combination for storing data that is manipulated by the one or more cellular baseband processors 904 or baseband units when executing software. The one or more cellular baseband processors 904 or baseband units individually or in combination further include a reception component 930, a communication manager 932, and a transmission component 934. The communication manager 932 includes the one or more illustrated components. The components within the communication manager 932 may be stored in the computer-readable medium/one or more memories and/or configured as hardware within the one or more cellular baseband processors 904 or baseband units. The one or more cellular baseband processors 904 or baseband units may be components of the UE 104, base station 102/180, disaggregated base station 181, or wireless device 310, 350, and may individually or in combination include the one or more memories 360, 376 and/or at least one of the one or more TX processors 316, 368, at least one of the one or more RX processors 356, 370 and at least one of the one or more controllers/processors 359, 375. For example, the reception component 930 may include the one or more RX processors 356, 370, the communication manager 932 may include the one or more controllers/processors 359, 375 and the one or more memories 360, 376, and the transmission component 934 may include the one or more TX processors 316, 368. In one configuration, the apparatus 902 may be a modem chip and include just the one or more baseband processors 904, and in another configuration, the apparatus 902 may be the entire UE (e.g., wireless device 350 of FIG. 3) and include the aforediscussed additional modules of the apparatus 902. In another configuration, the apparatus 902 may include just the baseband units, and in another configuration, the apparatus 902 may be the entire base station (e.g., wireless device 310 of FIG. 3) and include the aforediscussed additional modules of the apparatus 902.

When the apparatus 902 or first wireless device is a UE, the transmission component 934 may be configured to transmit capability information indicating support for link adaptation based on a partial code block group, such as described in connection with block 802 of FIG. 8. The reception component 930 may also be configured to receive an acknowledgement of the support prior to establishment of an RRC connection with the second wireless device, such as described in connection with block 804 of FIG. 8. The reception component 930 may also be configured to receive an indication of a granularity of the partial code block group prior to establishment of the RRC connection with the second wireless device, such as described in connection with block 806 of FIG. 8.

When the apparatus 902 or first wireless device is a network entity, the reception component 930 may be configured to receive capability information indicating support for link adaptation based on a partial code block group, such as described in connection with block 803 of FIG. 8. The transmission component 934 may also be configured to transmit an acknowledgement of the support prior to establishment of an RRC connection with the second wireless device, such as described in connection with block 805 of FIG. 8. The transmission component 934 may also be configured to transmit an indication of a granularity of the partial code block group prior to establishment of the RRC connection with the second wireless device, such as described in connection with block 806 of FIG. 8.

When the apparatus 902 or first wireless device is either a UE or a network entity, the communication manager 932 may include a message component 940 that is configured to send a message indicating the partial code block group, the partial code block group being indicated via the quantity representing the fraction of the code block group, such as described in connection with block 808 of FIG. 8. The communication manager 932 may also include a code block group component 942 that is configured to obtain, in response to a non-acknowledgment of the code block group, retransmitted data in the partial code block group and additional data in a remainder of the code block group, such as described in connection with block 818 of FIG. 8. The reception component 930 may also be configured to receive a transmission having a plurality of code block groups including the code block group, such as described in connection with block 810 of FIG. 8. The transmission component 934 may also be configured to transmit an ACK/NACK report including an ACK or a NACK for each of the plurality of the code block groups, where the message indicating the partial code block group is sent in the ACK/NACK report with a non-acknowledgement of the code block group, such as described in connection with block 812 of FIG. 8. The transmission component 934 may additionally or alternatively be configured to transmit a CSF report recommending or indicating a MCS associated with a target BLER, where the message indicating the partial code block group is sent in the CSF report, such as described in connection with block 814 of FIG. 8. When the apparatus 902 or first wireless device is a UE, the transmission component 934 may additionally or alternatively be configured to transmit UCI, where the message indicating the partial code block group is sent in the UCI, such as described in connection with block 816 of FIG. 8.

The apparatus may include additional components that perform each of the blocks of the algorithm in the aforementioned flowchart of FIG. 8. As such, each block in the aforementioned flowchart of FIG. 8 may be performed by a component and the apparatus may include one or more of those components. The components may be one or more hardware components specifically configured to carry out the stated processes/algorithm, implemented by one or more processors individually or in combination configured to perform the stated processes/algorithm, stored within a computer-readable medium for implementation by one or more processors, or some combination thereof.

In one configuration, the apparatus 902, and in particular the one or more cellular baseband processors 904 or baseband units, includes means for sending, to a wireless device, a message indicating a partial code block group, the partial code block group being indicated via a quantity representing a fraction of a code block group; and means for obtaining, in response to a non-acknowledgment of the code block group, retransmitted data in the partial code block group and additional data in a remainder of the code block group. The aforementioned means may be one or more of the aforementioned components of the apparatus 902 configured to perform the functions recited by the aforementioned means. Moreover, as described supra, the apparatus 902 may include the one or more TX Processors 316, 368, the one or more RX Processors 356, 370, and the one or more controllers/processors 359, 375. As such, in one configuration, the aforementioned means may be at least one of the one or more TX Processors 316, 368, at least one of the one or more RX Processors 356, 370, or at least one of the one or more controllers/processors 359, 375 individually or in any combination configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, a processor, at least one processor, and/or one or more processors, individually or in combination, configured to perform or operable for performing a plurality of actions (such as the functions described supra) is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

Similarly as used herein, a memory, at least one memory, a computer-readable medium, and/or one or more memories, individually or in combination, configured to store or having stored thereon instructions executable by one or more processors for performing a plurality of actions (such as the functions described supra) is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, a computer-readable medium, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, a second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processors may in combination execute the respective subset of instruction to accomplish performing actions X, Y, and Z. Alternatively, a single processor may execute the instructions stored on a single memory, or distributed across multiple memories, to accomplish performing actions X, Y, and Z.

The following examples are illustrative only and may be combined with aspects of other embodiments or teachings described herein, without limitation.

Clause 1. An apparatus for wireless communication, comprising: one or more memories; and one or more processors each communicatively coupled with at least one of the one or more memories, the one or more processors, individually or in any combination, operable to cause the apparatus to: send, to a wireless device, a message indicating a partial code block group, the partial code block group being indicated via a quantity representing a fraction of a code block group; and obtain, in response to a non-acknowledgment of the code block group, retransmitted data in the partial code block group and additional data in a remainder of the code block group.

Clause 2. The apparatus of clause 1, wherein the partial code block group is based on mutual information between the apparatus and the wireless device which is observed from code block groups transmitted or received in a historical window of one or more slots.

Clause 3. The apparatus of clause 2, wherein the mutual information represents an average spectral efficiency observed in the historical window.

Clause 4. The apparatus of any of clauses 1 to 3, wherein the partial code block group is based on a first spectral efficiency (SE) threshold and a second SE threshold corresponding to a target block error rate (BLER), wherein the first SE threshold corresponds to a minimum amount of spectral efficiency observed from code block groups transmitted or received in a historical window of one or more slots, and wherein the second SE threshold corresponds to an amount of spectral efficiency under which a percentage of the one or more slots or the code block groups, equal to the target BLER, experienced reception failure during the historical window.

Clause 5. The apparatus of clause 4, wherein the quantity indicating the partial code block group is a function of the first SE threshold and a difference between the second SE threshold and the first SE threshold.

Clause 6. The apparatus of any of clauses 1 to 5, wherein the one or more processors, individually or in any combination, are operable to cause the apparatus to: receive, from the wireless device, a transmission having a plurality of code block groups including the code block group; and transmit an acknowledgment (ACK)/non-acknowledgement (NACK) report including an ACK or a NACK for each of the plurality of the code block groups, wherein the message indicating the partial code block group is sent in the ACK/NACK report with the non-acknowledgement of the code block group.

Clause 7. The apparatus of any of clauses 1 to 6, wherein the one or more processors, individually or in any combination, are operable to cause the apparatus to: transmit, to the wireless device, a channel state feedback (CSF) report recommending or indicating a modulation and coding scheme (MCS) associated with a target BLER, wherein the message indicating the partial code block group is sent in the CSF report.

Clause 8. The apparatus of any of clauses 1 to 7, wherein the one or more processors, individually or in any combination, are operable to cause the apparatus to: transmit, to the wireless device, uplink control information (UCI), wherein the message indicating the partial code block group is sent in the UCI.

Clause 9. The apparatus of any of clauses 1 to 8, wherein the one or more processors, individually or in any combination, are operable to cause the apparatus to: transmit, to the wireless device, capability information indicating support for link adaptation based on the partial code block group; and receive an acknowledgement of the support prior to establishment of a radio resource control (RRC) connection with the wireless device, the message indicating the partial code block group being sent after the establishment of the RRC connection.

Clause 10. The apparatus of any of clauses 1 to 8, wherein the one or more processors, individually or in any combination, are operable to cause the apparatus to: receive, from the wireless device, capability information indicating support for link adaptation based on the partial code block group; and transmit an acknowledgement of the support prior to establishment of a radio resource control (RRC) connection with the wireless device, the message indicating the partial code block group being sent after the establishment of the RRC connection.

Clause 11. The apparatus of any of clauses 1 to 10, wherein the one or more processors, individually or in any combination, are operable to cause the apparatus to: receive or transmit an indication of a granularity of the partial code block group prior to establishment of a radio resource control (RRC) connection with the wireless device, the granularity being a number of bits corresponding to the quantity representing the fraction of the partial code block group.

Clause 12. The apparatus of any of clauses 1 to 11, wherein the apparatus is a user equipment (UE), the wireless device is a network entity, and the retransmitted data is downlink data.

Clause 13. The apparatus of any of clauses 1 to 11, wherein the apparatus is a network entity, the wireless device is a user equipment (UE), and the retransmitted data is uplink data.

Clause 14. A method of wireless communication performable at a first wireless device, comprising: sending, to a second wireless device, a message indicating a partial code block group, the partial code block group being indicated via a quantity representing a fraction of a code block group; and obtaining, in response to a non-acknowledgment of the code block group, retransmitted data in the partial code block group and additional data in a remainder of the code block group.

Clause 15. The method of clause 14, wherein the partial code block group is based on mutual information between the first wireless device and the second wireless device which is observed from code block groups transmitted or received in a historical window of one or more slots.

Clause 16. The method of clause 15, wherein the mutual information represents an average spectral efficiency observed in the historical window.

Clause 17. The method of any of clauses 14 to 16, wherein the partial code block group is based on a first spectral efficiency (SE) threshold and a second SE threshold corresponding to a target block error rate (BLER), wherein the first SE threshold corresponds to a minimum amount of spectral efficiency observed from code block groups transmitted or received in a historical window of one or more slots, and wherein the second SE threshold corresponds to an amount of spectral efficiency under which a percentage of the one or more slots or the code block groups, equal to the target BLER, experienced reception failure during the historical window.

Clause 18. The method of clause 17, wherein the quantity indicating the partial code block group is a function of the first SE threshold and a difference between the second SE threshold and the first SE threshold.

Clause 19. The method of any of clauses 14 to 18, further comprising: receiving, from the second wireless device, a transmission having a plurality of code block groups including the code block group; and transmitting an acknowledgment (ACK)/non-acknowledgement (NACK) report including an ACK or a NACK for each of the plurality of the code block groups, wherein the message indicating the partial code block group is sent in the ACK/NACK report with the non-acknowledgement of the code block group.

Clause 20. The method of any of clauses 14 to 19, further comprising: transmitting, to the second wireless device, a channel state feedback (CSF) report recommending or indicating a modulation and coding scheme (MCS) associated with a target BLER, wherein the message indicating the partial code block group is sent in the CSF report.

Clause 21. The method of any of clauses 14 to 20, further comprising: transmitting, to the second wireless device, uplink control information (UCI), wherein the message indicating the partial code block group is sent in the UCI.

Clause 22. The method of any of clauses 14 to 21, further comprising: transmitting, to the second wireless device, capability information indicating support for link adaptation based on the partial code block group; and receiving an acknowledgement of the support prior to establishment of a radio resource control (RRC) connection with the second wireless device, the message indicating the partial code block group being sent after the establishment of the RRC connection.

Clause 23. The method of any of clauses 14 to 21, further comprising: receiving, from the second wireless device, capability information indicating support for link adaptation based on the partial code block group; and transmitting an acknowledgement of the support prior to establishment of a radio resource control (RRC) connection with the second wireless device, the message indicating the partial code block group being sent after the establishment of the RRC connection.

Clause 24. The method of any of clauses 14 to 23, further comprising: receiving or transmitting an indication of a granularity of the partial code block group prior to establishment of a radio resource control (RRC) connection with the second wireless device, the granularity being a number of bits corresponding to the quantity representing the fraction of the partial code block group.

Clause 25. The method of any of clauses 14 to 24, wherein the first wireless device is a user equipment (UE), the second wireless device is a network entity, and the retransmitted data is downlink data.

Clause 26. The method of any of clauses 14 to 24, wherein the first wireless device is a network entity, the second wireless device is a user equipment (UE), and the retransmitted data is uplink data.

Clause 27. An apparatus for wireless communication, comprising: means for sending, to a wireless device, a message indicating a partial code block group, the partial code block group being indicated via a quantity representing a fraction of a code block group; and means for obtaining, in response to a non-acknowledgment of the code block group, retransmitted data in the partial code block group and additional data in a remainder of the code block group.

Clause 28. The apparatus of clause 27, wherein the apparatus is a user equipment (UE), the wireless device is a network entity, and the retransmitted data is downlink data.

Clause 29. The apparatus of clause 27, wherein the apparatus is a network entity, the wireless device is a user equipment (UE), and the retransmitted data is uplink data.

Clause 30. One or more non-transitory, computer-readable media comprising computer executable code, the code when executed by one or more processors causes the one or more processors to, individually or in combination: send, to a wireless device, a message indicating a partial code block group, the partial code block group being indicated via a quantity representing a fraction of a code block group; and obtain, in response to a non-acknowledgment of the code block group, retransmitted data in the partial code block group and additional data in a remainder of the code block group.

What is claimed is:

1. An apparatus for wireless communication, comprising:
one or more memories; and
one or more processors each communicatively coupled with at least one of the one or more memories, the one or more processors, individually or in any combination, operable to cause the apparatus to:
send, to a wireless device, a message indicating a partial code block group, the partial code block group being indicated via a quantity representing a fraction of a code block group; and
obtain, in response to a non-acknowledgment of the code block group, retransmitted data in the partial code block group and additional data in a remainder of the code block group.

2. The apparatus of claim 1, wherein the partial code block group is based on mutual information between the apparatus and the wireless device which is observed from code block groups transmitted or received in a historical window of one or more slots.

3. The apparatus of claim 2, wherein the mutual information represents an average spectral efficiency observed in the historical window.

4. The apparatus of claim 1,
wherein the partial code block group is based on a first spectral efficiency (SE) threshold and a second SE threshold corresponding to a target block error rate (BLER),
wherein the first SE threshold corresponds to a minimum amount of spectral efficiency observed from code block groups transmitted or received in a historical window of one or more slots, and
wherein the second SE threshold corresponds to an amount of spectral efficiency under which a percentage of the one or more slots or the code block groups, equal to the target BLER, experienced reception failure during the historical window.

5. The apparatus of claim 4, wherein the quantity indicating the partial code block group is a function of the first SE threshold and a difference between the second SE threshold and the first SE threshold.

6. The apparatus of claim 1, wherein the one or more processors, individually or in any combination, are operable to cause the apparatus to:
receive, from the wireless device, a transmission having a plurality of code block groups including the code block group; and
transmit an acknowledgment (ACK)/non-acknowledgement (NACK) report including an ACK or a NACK for each of the plurality of the code block groups, wherein the message indicating the partial code block group is sent in the ACK/NACK report with the non-acknowledgement of the code block group.

7. The apparatus of claim 1, wherein the one or more processors, individually or in any combination, are operable to cause the apparatus to:
transmit, to the wireless device, a channel state feedback (CSF) report recommending or indicating a modulation and coding scheme (MCS) associated with a target BLER, wherein the message indicating the partial code block group is sent in the CSF report.

8. The apparatus of claim 1, wherein the one or more processors, individually or in any combination, are operable to cause the apparatus to:
transmit, to the wireless device, uplink control information (UCI), wherein the message indicating the partial code block group is sent in the UCI.

9. The apparatus of claim 1, wherein the one or more processors, individually or in any combination, are operable to cause the apparatus to:
transmit, to the wireless device, capability information indicating support for link adaptation based on the partial code block group; and
receive an acknowledgement of the support prior to establishment of a radio resource control (RRC) connection with the wireless device, the message indicating the partial code block group being sent after the establishment of the RRC connection.

10. The apparatus of claim 1, wherein the one or more processors, individually or in any combination, are operable to cause the apparatus to:
receive, from the wireless device, capability information indicating support for link adaptation based on the partial code block group; and
transmit an acknowledgement of the support prior to establishment of a radio resource control (RRC) connection with the wireless device, the message indicating the partial code block group being sent after the establishment of the RRC connection.

11. The apparatus of claim 1, wherein the one or more processors, individually or in any combination, are operable to cause the apparatus to:
receive or transmit an indication of a granularity of the partial code block group prior to establishment of a radio resource control (RRC) connection with the wireless device, the granularity being a number of bits corresponding to the quantity representing the fraction of the partial code block group.

12. The apparatus of claim 1, wherein the apparatus is a user equipment (UE), the wireless device is a network entity, and the retransmitted data is downlink data.

13. The apparatus of claim 1, wherein the apparatus is a network entity, the wireless device is a user equipment (UE), and the retransmitted data is uplink data.

14. A method of wireless communication performable at a first wireless device, comprising:
sending, to a second wireless device, a message indicating a partial code block group, the partial code block group being indicated via a quantity representing a fraction of a code block group; and
obtaining, in response to a non-acknowledgment of the code block group, retransmitted data in the partial code block group and additional data in a remainder of the code block group.

15. The method of claim 14, wherein the partial code block group is based on mutual information between the first wireless device and the second wireless device which is observed from code block groups transmitted or received in a historical window of one or more slots.

16. The method of claim 15, wherein the mutual information represents an average spectral efficiency observed in the historical window.

17. The method of claim 14,
wherein the partial code block group is based on a first spectral efficiency (SE) threshold and a second SE threshold corresponding to a target block error rate (BLER),
wherein the first SE threshold corresponds to a minimum amount of spectral efficiency observed from code block groups transmitted or received in a historical window of one or more slots, and
wherein the second SE threshold corresponds to an amount of spectral efficiency under which a percentage of the one or more slots or the code block groups, equal to the target BLER, experienced reception failure during the historical window.

18. The method of claim 17, wherein the quantity indicating the partial code block group is a function of the first SE threshold and a difference between the second SE threshold and the first SE threshold.

19. The method of claim 14, further comprising:
receiving, from the second wireless device, a transmission having a plurality of code block groups including the code block group; and
transmitting an acknowledgment (ACK)/non-acknowledgement (NACK) report including an ACK or a NACK for each of the plurality of the code block groups, wherein the message indicating the partial code block group is sent in the ACK/NACK report with the non-acknowledgement of the code block group.

20. The method of claim 14, further comprising:
transmitting, to the second wireless device, a channel state feedback (CSF) report recommending or indicating a modulation and coding scheme (MCS) associated with a target BLER, wherein the message indicating the partial code block group is sent in the CSF report.

21. The method of claim 14, further comprising:
transmitting, to the second wireless device, uplink control information (UCI), wherein the message indicating the partial code block group is sent in the UCI.

22. The method of claim 14, further comprising:
transmitting, to the second wireless device, capability information indicating support for link adaptation based on the partial code block group; and
receiving an acknowledgement of the support prior to establishment of a radio resource control (RRC) connection with the second wireless device, the message indicating the partial code block group being sent after the establishment of the RRC connection.

23. The method of claim 14, further comprising:
receiving, from the second wireless device, capability information indicating support for link adaptation based on the partial code block group; and
transmitting an acknowledgement of the support prior to establishment of a radio resource control (RRC) connection with the second wireless device, the message indicating the partial code block group being sent after the establishment of the RRC connection.

24. The method of claim 14, further comprising:
receiving or transmitting an indication of a granularity of the partial code block group prior to establishment of a radio resource control (RRC) connection with the second wireless device, the granularity being a number of bits corresponding to the quantity representing the fraction of the partial code block group.

25. The method of claim 14, wherein the first wireless device is a user equipment (UE), the second wireless device is a network entity, and the retransmitted data is downlink data.

26. The method of claim 14, wherein the first wireless device is a network entity, the second wireless device is a user equipment (UE), and the retransmitted data is uplink data.

27. An apparatus for wireless communication, comprising:
means for sending, to a wireless device, a message indicating a partial code block group, the partial code block group being indicated via a quantity representing a fraction of a code block group; and
means for obtaining, in response to a non-acknowledgment of the code block group, retransmitted data in the partial code block group and additional data in a remainder of the code block group.

28. The apparatus of claim 27, wherein the apparatus is a user equipment (UE), the wireless device is a network entity, and the retransmitted data is downlink data.

29. The apparatus of claim 27, wherein the apparatus is a network entity, the wireless device is a user equipment (UE), and the retransmitted data is uplink data.

30. One or more non-transitory, computer-readable media comprising computer executable code, the code when executed by one or more processors causes the one or more processors to, individually or in combination:
send, to a wireless device, a message indicating a partial code block group, the partial code block group being indicated via a quantity representing a fraction of a code block group; and
obtain, in response to a non-acknowledgment of the code block group, retransmitted data in the partial code block group and additional data in a remainder of the code block group.
